(19) United States
(12) Patent Application Publication
(10) Pub. No.: US 2017/0095985 A1
(43) Pub. Date: Apr. 6, 2017

(54) BINDER ACTIVATION BY MEANS OF LIGHT-EMITTING DIODES IN THE PRODUCTION OF FIBRE-REINFORCED PLASTIC LAMINATE

(71) Applicant: Airbus Defence and Space GmbH, Taufkirchen (DE)

(72) Inventors: Franz Engel, Taufkirchen (DE); Tilman Orth, Taufkirchen (DE); Christian Weimer, Taufkirchen (DE); Katharina Schlegel, Taufkirchen (DE)

(21) Appl. No.: 15/284,108

(22) Filed: Oct. 3, 2016

(30) Foreign Application Priority Data
Oct. 5, 2015 (DE) 102015116837.5

(51) Int. Cl. B29C 70/38; B29C 70/34; B29C 71/04; B29C 71/02; B32B 38/00; B32B 7/04; B32B 27/06; B32B 27/18; B32B 5/10; B32B 37/06; B29C 70/16; B29C 35/08

(52) U.S. Cl. CPC B29C 70/384; B29C 70/16; B29C 70/34; B29C 71/04; B29C 71/02; B29C 35/0805; B32B 7/04; B32B 27/06; B32B 27/18; B32B 5/10; B32B 37/06; B32B 38/0008; B29K 2105/253

(57) ABSTRACT

An activation device used for binder activation during the production of a fiber-reinforced plastic laminate. The activation device has at least one light-emitting diode for heating a portion of at least one semi-finished fiber ribbon. A method is used for producing a fiber-reinforced plastic laminate. It comprises automatically laying at least one semi-finished fiber ribbon on a laying support, heating at least one portion of the semi-finished fiber ribbon by means of one or more light-emitting diode(s) of an activation device, and pressing the heated portion of the semi-finished fiber ribbon on the laying support.

### CROSS-REFERENCES TO RELATED APPLICATIONS

This application claims the benefit of the German patent application No. 10 2015 116 837.5 filed on Oct. 5, 2015, the entire disclosures of which are incorporated herein by way of reference.

### FIELD OF THE INVENTION

The invention relates to an activation device for binder activation during the production of a fiber-reinforced plastic laminate, to a device for producing a fiber-reinforced plastic laminate and to a method for producing a fiber-reinforced plastic laminate.

### BACKGROUND OF THE INVENTION

Fiber composite plastics are used in many areas. For example, carbon fiber-reinforced plastics are used, inter alia, in industrial components, in aerospace technology and in sports equipment. The production of the corresponding components can comprise, in particular, automatic layer deposition processes. In this respect, dry or pre-impregnated fibers are laid by a laying head in narrow semi-finished fiber ribbons in a plurality of layers in a forming tool. At present, a laying head can simultaneously lay up to 32 semi-finished fiber ribbons next to one another on a laying support, which can be formed by a forming tool and/or by a layer which has already been laid. During the laying procedure, the laying head can automatically travel along curves and, while so doing, can adjust the laying speed of the individual semi-finished fiber ribbons, which are guided next to one another, to the particular curvature of the path. A component is constructed in this way from a plurality of layers.

The laid semi-finished fiber ribbons can be pre-impregnated with, for example, thermoset matrix material or with thermoplastic matrix material or they can be used as dry fibers with binder.

So that the semi-finished fiber ribbons can no longer slip or move after being laid down, a binder which is contained therein is preferably activated by heating; the (activation) temperature which is required in each case depends on the matrix material or binder which is used. As a result of the heating procedure, the semi-finished fiber ribbons develop a tackiness which allows them to adhere to their particular laying position. Furthermore, semi-finished fiber ribbons with thermoplastic matrix material can be immediately consolidated with the right combination of pressure and temperature.

According to conventional uses, heating is carried out using infrared radiators or lasers, and occasionally hot gas or a contact line is also used. In the case of semi-finished fiber ribbons with thermoset matrix material, infrared heaters are used, in particular, in the case of semi-finished fiber ribbons with thermoplastic matrix material, laser heaters are frequently used.

The conventional radiation heating means suffer from a few disadvantages. Thus, infrared radiators have a low power density, are badly focused and cannot be controlled individually for each ribbon. Although lasers provide a very high power density, the use thereof implies a considerable safety risk due to their high power in relatively large production plants. Hot gas torches are difficult to control and gauge and are also flammable, and contact heating systems are complex to realize in terms of apparatus in production plants for fiber-reinforced plastic laminates and are therefore generally not practical.

### SUMMARY OF THE INVENTION

It is one idea of the present invention to provide a novel method for producing a fiber-reinforced plastic laminate, and by using this method, the mentioned disadvantages are avoided.

According to a first aspect of the invention, an activation device for binder activation during the production of a fiber-reinforced plastic laminate comprises at least one light-emitting diode for heating a portion of at least one semi-finished fiber ribbon.

According to a second aspect of the invention, a method for producing a fiber-reinforced plastic laminate comprises automatically laying at least one semi-finished fiber ribbon on a laying support, heating at least one portion of the semi-finished fiber ribbon and pressing the heated portion of the semi-finished fiber ribbon on the laying support. The portion of the semi-finished fiber ribbon is heated by means of one or more light-emitting diodes of an activation device.

According to a third aspect of the invention, a device for producing a fiber-reinforced plastic laminate comprises a feed means for feeding at least one semi-finished fiber ribbon onto a laying support, an activation device according to the invention, and a compacting element for pressing the heated portion of the semi-finished fiber ribbon on the laying support.

A device according to the invention for producing a fiber-reinforced plastic laminate comprises a feed means (which can comprise, for example, a material roller and/or a laying unit) for delivering at least one semi-finished fiber ribbon onto a laying support; in particular, the feed means can be configured to feed to the laying support a plurality of semi-finished fiber ribbons substantially at the same time and/or in parallel. The device also comprises an activation unit according to the invention, in accordance with one of the embodiments mentioned in this document, as well as a compacting element (which can be configured, for example, as a planar press or as a compacting roller) for pressing a portion, heated by the activation unit, of the at least one semi-finished fiber ribbon on the laying support. The at least one semi-finished fiber ribbon is fed preferably automatically by the feed means. In particular, according to a variant, at least the feed means is part of a laying head of an automatic layer deposition installation.

It is understood that the particular portion, which the activation device is configured to heat or which is heated (according to a method of the invention), can change over time so that therefore a plurality of portions can be heated successively (in a continuous conveyance or in discrete intervals), for example when the activation device is moved along a delivered semi-finished fiber ribbon and/or when a delivered semi-finished fiber ribbon is moved past the activation device.

The semi-finished fiber ribbon(s) preferably comprises/comprise a carbon fiber-reinforced material (which is pre-impregnated or dry, charged with binder) or even consists thereof The laying support can be, for example, a substrate and/or a previously laid layer and/or a forming tool.

An activation device according to the invention or a method according to the invention make it possible to heat portions of a semi-finished fiber ribbon, which heating procedure can be realized simply using the device. Heating by means of light-emitting diode(s) can be controlled particularly easily, so that the particular heating can be adapted, in particular, to local requirements when the semi-finished fiber ribbon(s) is/are laid (which requirements can arise, for example, from the spatial form of a component to be produced from fiber-reinforced plastic laminate). In this way, a binder material can be activated in the at least one semi-finished fiber ribbon and a tackiness thereof can thus be produced, which prevents the laid semi-finished fiber ribbons from moving and thus ensures a good quality of a fiber-reinforced plastic laminate which is to be produced.

According to an embodiment, an activation device according to the invention comprises a temperature measuring device for detecting a temperature of the heated portion and/or of the activation device (or of a part or region of the activation device, for example of the at least one light-emitting diode) and/or of a heated laying support (in particular when the portion of the at least one semi-finished fiber ribbon is heated indirectly in this way; in this case, the temperature is preferably detected before the portion of the semi-finished fiber ribbon is deposited on the laying support). According to a variant, a method according to the invention analogously comprises detecting a temperature of the heated portion of the semi-finished fiber ribbon and/or of the activation device (or of a part or region thereof, for example of the at least one light-emitting diode) and/or of a heated laying support (in this case the detection preferably taking place before the portion of the semi-finished fiber ribbon has been laid on said laying support).

The temperature can be detected directly, in particular without contact, using at least one pyrometer, or indirectly, for example by means of at least one thermistor which is configured to detect a heating effect (for example, of the light-emitting diode(s).

A temperature measurement of this type allows the heating of the at least one semi-finished fiber ribbon to be monitored. In particular, a quality of the fiber-reinforced plastic laminate which is to be produced can be ensured thereby.

One embodiment of a method according to the invention is particularly preferred in which a plurality of semi-finished fiber ribbons are laid simultaneously, substantially parallel on the laying support, the temperature of said ribbons in the heated portion being detected separately (individually or in groups with a plurality of semi-finished fiber ribbons) (optionally in addition to a temperature of the activation device and/or of a heated laying support). In an analogous manner, an activation device according to the invention is preferably configured to heat a plurality of semi-finished fiber ribbons, which have been simultaneously laid next to one other, in one portion, and the temperature measuring device which is preferably comprised is configured to separately detect the temperature of the heated portion individually or in groups for the plurality of semi-finished fiber ribbons (optionally in addition to a temperature of the activation device and/or of a heated laying support).

For example, the shape of a fiber-reinforced plastic laminate which is to be produced can require parallel laid semi-finished fiber ribbons to be stressed (for example extended) to different extents, for example when they are laid next to one another along a curve or a camber. In such cases, different temperatures can be required for the different semi-finished fiber ribbons for efficient binder activation, for example according to the particular stress and/or thickness of a portion. The mentioned embodiment makes it possible to separately detect the respectively attained temperature for different semi-finished fiber ribbons in each case individually or in groups (which can comprise, for example two or more adjacently laid semi-finished fiber ribbons) and to thus monitor them.

The light-emitting diode(s) can be configured to emit electromagnetic radiation in the visible and/or invisible wavelength range. It/they can be configured to be operated only in continuous operation, only in a pulsed or varying manner (preferably optionally) in continuous operation or in a pulsed manner. According to an embodiment of a method according to the invention, the light-emitting diode(s) is/are accordingly operated only in continuous operation, only in a pulsed or varying manner.

The light-emitting diode(s) is/are preferably fitted (for example soldered) to one of the plurality of plates which can comprise at least one planar and/or curved region. In particular, a surface of the activation device with light-emitting diode(s) can thereby be adapted to the plastic laminate to be produced. This surface of the activation device with light-emitting diode(s) can then face the portion to be heated (in particular the portion which is thereafter pressed by a compacting element onto the laying support). In this way, a particularly favorable heating can be achieved.

The light-emitting diode(s) preferably respectively comprise semiconductor components. It is thereby possible to realize short response times and a good controllability. The light-emitting diode(s) can comprise or can be one or more high-power LED(s) which can be configured, for example, as surface-mounted components (for which the English term “surface mounted device” (SMD) is also a common expression in technical terminology), or the light-emitting diode(s) can be produced by through-hole assembly (for which the English term “through-hole technology” (THT) is also used in technical terminology). Alternatively or additionally, the activation device can comprise one or more fiber-form or film-form light-emitting diode(s).

The activation device with the light-emitting diode(s) can comprise a region, through which a coolant flows. In this way, heat loss from the light-emitting diode(s) can be dissipated. To improve the heat dissipation, alternatively or additionally the activation device can also comprise a cooling body which consists of or at least comprises the same material as the plate(s); a cooling body of this type can be produced, for example by an additive process. It can prevent a transfer of heat.

The activation device can comprise one or more light-emitting diodes which are configured to be directed onto a portion which has been laid or is to be laid of the at least one semi-finished fiber ribbon and to irradiate or heat it directly in this way. Alternatively or additionally, the activation device can comprise one or more light-emitting diodes which are configured to be directed onto a region of the laying support to which the at least one semi-finished fiber ribbon is delivered. In this manner, the activation device can be configured to heat the portion indirectly, in that the laying support conveys its heat, received from the activation device, to the at least one semi-finished fiber ribbon. This embodiment also has the advantage that a binder material in an optionally previously laid layer of fiber semi-finished product is activated in the laying support and thereby intensifies the adhesion of the portion of the semi-finished fiber ribbon.

According to an embodiment, an activation device according to the invention comprises a control unit for the light-emitting diode(s); the power of the light-emitting diode(s) can preferably be controlled thereby.

One embodiment is particularly preferred in which the activation device comprises a plurality of light-emitting diodes which can be controlled individually and/or in groups. Analogously, a method according to the invention preferably comprises a control of the light-emitting diode(s) which, in the case of a plurality of light-emitting diodes, comprised by the activation device, can be carried out individually and/or in groups.

The light-emitting diodes can be controlled on the basis of previously established, preferably stored material parameters and/or process parameters which the control unit of the activation device can preferably access.

If the activation device according to the invention comprises a control unit as mentioned, said control unit is preferably configured to control the output of the respective light-emitting diode(s) on the basis of at least one particular temperature, for example a temperature of the heated portion of the at least one semi-finished fiber ribbon and/or of the heated laying support and/or of the activation device (or a part or region of the activation device, for example of the at least one light-emitting diode) which, as mentioned above, can be detected by a temperature measuring device; a control of this type preferably comprises a comparison of at least one detected value with one or more set value(s) (which can be stored in a memory of the control unit or on a storage medium which the control unit can access).

By means of the control, thermal damage to the laid fiber material can be avoided and a precise heating procedure and thereby binder activation can be achieved and monitored, conforming exactly with the respective circumstances and requirements.

In particular, the control unit of the activation device can provide or allow a manual and/or automatic connection and disconnection of one or more light-emitting diodes in each case for individual semi-finished fiber ribbons.

A segmentation of the light-emitting diodes into groups which can be controlled separately from one another (preferably even independently of one another) can be constant or can be adjusted in a variable manner, for example by a user and/or automatically on the basis of one or more process parameters. It can be based, for example, on an arrangement of a plurality of light-emitting diodes on a plate. Thus, for example light-emitting diodes which are arranged on peripheral regions of a plate of the activation device can form a first group of light-emitting diodes, and light-emitting diodes in a central region of the plate can form a second group of light-emitting diodes. Alternatively or additionally, the light-emitting diodes can be divided (optionally into subgroups) according to which direction the light-emitting diodes respectively emit radiation, whether they are configured for example to be directed onto semi-finished fiber ribbons which have been laid or are to be laid or onto the laying support. The light-emitting diodes of the different (sub) groups can then be controlled separately, preferably independently of one another.

Heating profiles and/or temperature ramps can be adjustable by virtue of a (sub)segmentation in the longitudinal direction of the at least one delivered semi-finished fiber ribbon, in which, therefore, different groups of controllable light-emitting diodes are arranged along (optionally each or a plurality of) semi-finished fiber ribbons in the longitudinal direction. For example, in this way, light-emitting diodes which, during an intended use of the activation device, are arranged relatively close to a compacting roller, formed as a compacting element, can form a different group compared to light-emitting diodes which are accordingly arranged further away from the compacting roller. For example, a lower heating power can thereby be adjusted for the first-mentioned group compared to the second-mentioned group, so that a region of the at least one semi-finished fiber ribbon, which is later engaged by the compacting roller, is (initially) heated to a greater extent than another region. A cooling during the rolling by the compacting roller can thus be equalized.

According to a variant, an activation unit according to the invention is configured to be integrated into a laying head, which can move relative to a laying support, of a device for producing a fiber-reinforced plastic laminate or is configured to be attached to a laying head of this type. In this respect, the laying head is configured to automatically unroll the at least one semi-finished fiber ribbon on the laying support and to thus position it successively.

The at least one light-emitting diode of the activation device can be configured to irradiate the portion to be heated or the laying support for the at least one semi-finished fiber ribbon in a direct manner, i.e., without an interpositioned medium.

According to an alternative embodiment, an activation device according to the invention comprises at least one optical component which is configured to influence, for example to refract, to direct, to focus, to deflect, to split or the like, radiation emitted from the at least one light-emitting diode between the at least one light-emitting diode and the portion and/or between the at least one light-emitting diode and a laying support, irradiated thereby, for the at least one semi-finished fiber ribbon. Optical components of this type can be, for example one or more mirrors, light guides, lens(es), prism(s) and/or diaphragm(s).

An embodiment of a method according to the invention analogously comprises passing radiation through at least one optical component between the at least one light-emitting diode and the portion of the at least one semi-finished fiber ribbon and/or between the at least one light-emitting diode and a laying support, irradiated thereby, for the at least one semi-finished fiber ribbon.

In this way, the emitted radiation can be directed in a particularly suitable manner onto the at least one portion of the at least one semi-finished fiber ribbon or onto the laying support and thus an optimum heating and thereby binder activation can be achieved. In particular, the irradiation can be precisely oriented and thus controlled, so that for example adjacent semi-finished fiber ribbons can also be irradiated differently and (at least substantially) without any overlaps.

In one embodiment, an optical component of this type comprises at least one Fresnel lens; an activation device having a lens of this type can be integrated in a particularly effective and compact manner, due to its low weight and volume.

According to a variant, an activation device according to the invention comprises a light guide which is configured to transmit radiation (or radiant energy) from the at least one light-emitting diode to the portion (to be heated) and/or to the laying support (to be heated); in this case, the at least one light-emitting diode thus heats said portion or laying support indirectly. A method according to the invention can analogously comprise feeding radiation from the at least one light-emitting diode into a light guide and supplying the radiant energy through the light guide to the portion of the semi-finished fiber ribbon and/or to the laying support. Embodiments of this type make it possible, in particular, to arrange the at least one light-emitting diode at a spatial distance from a feed means and from a compacting element, for example outside a forming tool. Consequently, the at least one light-emitting diode is better protected and less susceptible to soiling, for example. Furthermore, it is easier to service.

The activation device can also comprise a discharge body for the radiation which can be connected and/or can be connectable (preferably releasably) to a light guide and which is preferably configured to receive radiation from the light guide and to release it to the surroundings. A discharge body of this type can preferably be adapted in its spatial form to a form of the compacting element (for example, a compacting roller) and/or of a fiber-reinforced plastic laminate to be respectively produced. As a result, a particularly good and energy-efficient heating can be achieved. The discharge body can comprise micro lenses in its interior. An emission of the radiation can be precisely controlled thereby.

The light guide and/or a discharge body which is optionally connected or can be connected thereto can be segmented so that radiation of a differing intensity respectively issues from the light guide or discharge body in different places. Thus, the light guide (or discharge body) can be configured, for example, to transmit and/or emit radiation of a first intensity in the direction of the at least one semi-finished fiber ribbon and to emit radiation of a second intensity, which is different from the first intensity, in the direction of the laying support. Alternatively or additionally, the light guide (or discharge body) can emit radiation of a differing intensity in the longitudinal direction of the at least one delivered semi-finished fiber ribbon, so that a suitable heating profile is or can be formed.

In particular, the discharge body can be segmented so that radiation can be directed specifically onto a portion of an (individual) or a plurality of semi-finished fiber ribbons and/or onto the laying support, depending on a region in which it is fed into the discharge body.

A method according to the invention can be part of an automated layer deposition process, for example a so-called AFP, DFP and/or ATL process. Alternatively, an automated application method of (additional) unidirectional layers onto a braided component can comprise a method according to the invention.

The embodiments and developments above can, where appropriate, be combined with one another as desired. Further possible embodiments, developments and implementations of the invention also include not explicitly mentioned combinations of features of the invention described above or in the following with reference to the embodiments. In particular, in this case, a person skilled in the art will also add individual aspects as improvements or supplements to the respective basic forms of the present invention.

### BRIEF DESCRIPTION OF THE DRAWINGS

In the following, the present invention will be described in more detail with reference to the embodiments represented in the schematic figures, in which:

FIG. 1 shows an exemplary device according to the invention for producing a fiber-reinforced plastic laminate.

FIG. 2 shows an activation device, in use, according to an exemplary embodiment of the present invention.

FIG. 3a, 3b are views of a possible irradiation of semi-finished fiber ribbons by means of an exemplary activation device according to the invention.

FIG. 4 shows an activation device, in use, according to a further exemplary embodiment of the present invention.

The accompanying figures are to provide a further understanding of the embodiments of the invention. They illustrate embodiments and, together with the description, serve to explain the principles and concepts of the invention. Other embodiments and many of the mentioned advantages are revealed in view of the drawings. The elements of the drawings have not necessarily been drawn true-to-scale relative to one another.

In the figures of the drawings, identical, functionally identical and identically acting elements, features and components have been respectively provided with the same reference numerals, unless indicated otherwise.

### DETAILED DESCRIPTION OF THE PREFERRED EMBODIMENTS

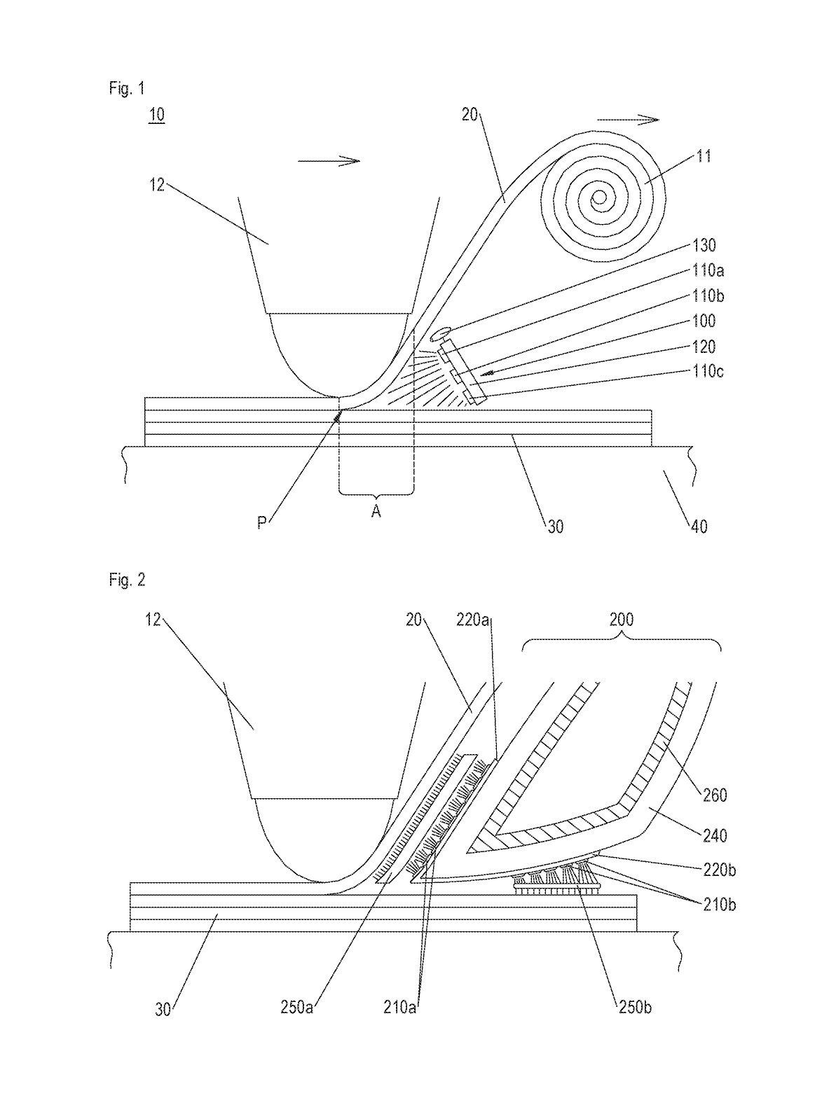

FIG. 1 shows a first exemplary device 10 according to the invention for producing a fiber-reinforced plastic laminate. The device comprises a feed means 11 for feeding at least one semi-finished fiber ribbon 20 onto a laying support 30. Due to the schematic side view of the device, only a single semi-finished fiber ribbon can be seen in FIG. 1; according to an advantageous embodiment, the feed means 11 delivers to the laying support 30 a plurality of semi-finished fiber ribbons, which extend in parallel, next to one another. In the situation shown, the laying support of the currently laid semi-finished fiber ribbon(s) 20 is a previously laid layer of semi-finished fiber ribbons; in another situation, the support could be a forming tool 40 and/or a substrate (not shown).

The feed means 11 is preferably configured to move relative to the laying support 30 in the direction of the arrow to deliver the semi-finished fiber ribbon successively to the laying support 30, in particular to deposit said ribbon thereon. In the figure, the feed means 11 is shown schematically as an unwinding roller, from which the at least one semi-finished fiber ribbon is unwound during the mentioned movement.

The device 10 also has a compacting element 12 for pressing portions of the at least one semi-finished fiber ribbon onto the laying support. The compacting element 12 is also preferably configured to move relative to the laying support 30 in the direction of the arrow. The at least one delivered and deposited semi-finished fiber ribbon can thereby be pressed in portions, i.e., gradually, onto the laying support.

Before a portion A of the semi-finished fiber ribbon is pressed on the laying support by the compacting element 12, it is heated by an activation device 100; in this way, a binder material in the semi-finished fiber ribbon is activated and thereby produces a tackiness of the semi-finished fiber ribbon, due to which the semi-finished fiber ribbon adheres to the laying support and in particular, does not slip.

In the example shown, the activation device 100 comprises a plate 120 on which light-emitting diodes 110a, 110b, 110c are mounted. In the example shown, the light-emitting diodes 110a, 110b, 110c are directed in particular or substantially onto the contact point P (or onto a straight line, running through said contact point, perpendicularly to the plane of the drawing), at which the delivered at least one semi-finished fiber ribbon is just contacting the laying support. The activation device with the light-emitting diodes 110a, 110b, 110c irradiates the portion A of the at least one semi-finished fiber ribbon 20 and thus heats it directly before it is pressed by the compacting element 12 onto the laying support. Furthermore, the portion is heated indirectly in that the activation device 100 also irradiates a region of the laying support 30, the heat of which then radiates onto the portion of the semi-finished fiber ribbon, particularly after said portion has been deposited.

The activation device 100 shown in FIG. 1 also has a temperature measuring device 130 for detecting a temperature of the heated portion A. In the present example, the temperature measuring device 130 is, for example, a pyrometer, directed onto region A, for detecting the temperature without making contact. The activation device 100 preferably comprises a control unit (not shown) which can control the light-emitting diodes on the basis of one or more temperatures detected thus; a control of this type preferably comprises a comparison of at least one detected value with one or more set value(s).

One embodiment is particularly preferred in which the light-emitting diodes 110a, 110b, 110c can be controlled individually and/or in groups. Thus, for example, subject to a detected temperature, the radiant power of the light-emitting diodes 110a, 110b and 110c could be adjusted independently of one another. If the activation device 100 has further light-emitting diodes in analogous positions (for example perpendicularly to the plane of the drawing), light-emitting diodes, for example, which are arranged along a straight line perpendicularly to the direction of the ribbons could be respectively combined into a common controllable group. In particular, for example light-emitting diodes which (like light-emitting diode 110c in the drawing) only irradiate the laying support, could thereby be adjusted in a different manner compared to light-emitting diodes which only irradiate the at least one semi-finished fiber ribbon to be laid (like light-emitting diode 110a in the drawing) and/or compared to light-emitting diodes which irradiate the semi-finished fiber ribbon to be laid as well as the laying support (like light-emitting diode 110b in the drawing). It is understood that, alternatively, other segmentations are possible.

FIG. 2 shows an activation device 200 in use, according to an alternative embodiment; the activation device 200 is heating a portion of a semi-finished fiber ribbon 20 which is laid on a laying support 30 and is pressed thereon by a compacting element 12, as in the procedure shown in FIG. 1.

The activation unit 200 comprises plates 220a, 220b which are respectively arranged on a surface of a basic body 240 of the activation unit 200 and on which a plurality of light-emitting diodes 210, 210b are respectively arranged. Some of the light-emitting diodes (namely those identified by 210a) are directed at a delivered portion of the semi-finished fiber ribbon 20 which is to be laid, in order to heat said portion. On the other hand, other light-emitting diodes (namely those identified by 210b) are directed at the laying support and thus indirectly heat the portion of the semi-finished fiber ribbon, in that the heat introduced into the laying support radiates into the portion of the semi-finished fiber ribbon after it has been applied. The light-emitting diodes can preferably be controlled individually or in groups (as described above).

Arranged inside the activation unit 200 is a cooling system 260, through which a cooling medium flows. In this way, heat loss from the light-emitting diode(s) can be dissipated.

The activation unit 200 further comprises two optical components 250a, 250b which are respectively lenses in the case shown. In this case, the optical component 250a is arranged between the activation device and the portion of semi-finished fiber ribbon to be heated or irradiated and the optical component 250b is arranged between the at least one light-emitting diode and the laying support 30, irradiated thereby, for the at least one semi-finished fiber ribbon. In both cases, the optical component is configured to influence, for example to refract and/or to focus radiation which is emitted by the at least one light-emitting diode. Consequently, it is possible to achieve a particularly advantageous irradiation and thus heating, which causes a corresponding binder activation and thereby adhesion of the semi-finished fiber ribbon to the laying support.

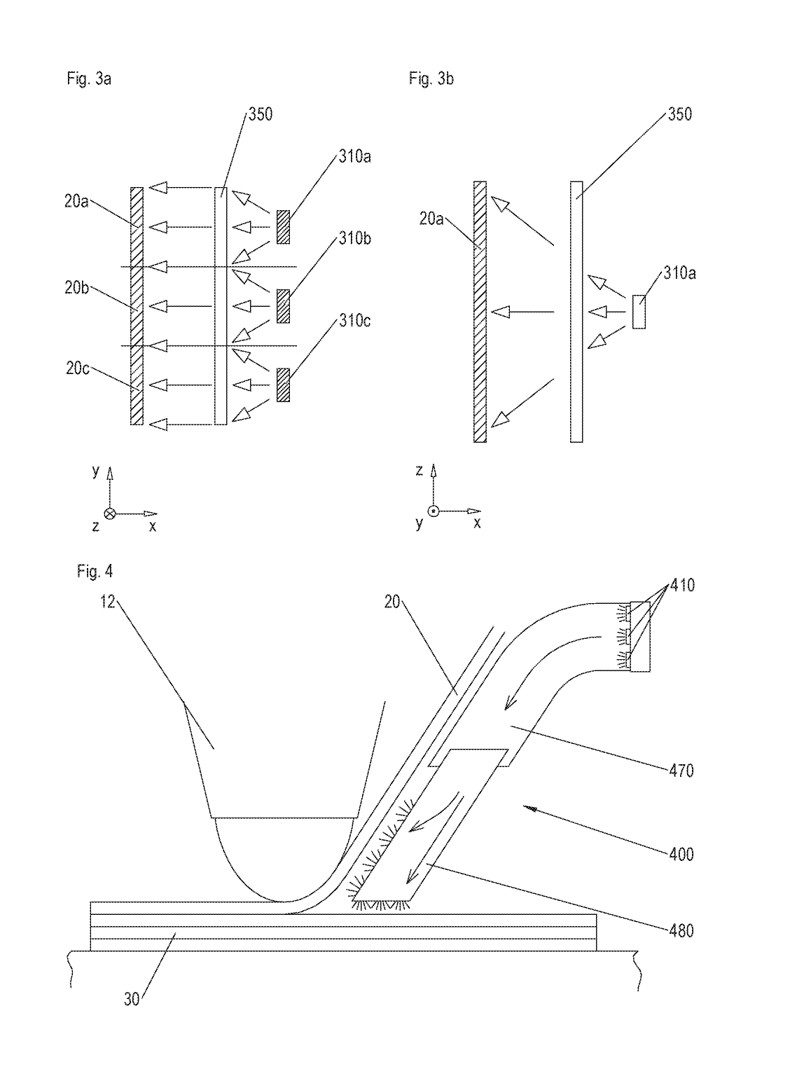

FIGS. 3a and 3b are two different perspective sketches of possible radiation paths of radiation which is emitted by light-emitting diodes 310a, 310b, 310c onto respective portions of semi-finished fiber ribbons 20a, 20b, 20c which extend in parallel. The different perspectives are marked in the figures by respectively indicated (x, y, z) coordinate systems.

FIG. 3a is a cross-sectional view of the semi-finished fiber ribbons 20a, 20b, 20c. Each of the semi-finished fiber ribbons 20a, 20b, 20c is irradiated by a light-emitting diode 310a, 310b, 310c associated therewith and is thus heated. The radiation is respectively passed through an optical component 350 (for example through a Fresnel lens) which, in the present case, refracts the radiation in a parallel manner and thereby orients it so that overlaps of the radiation from the different light-emitting diodes are prevented.

As can be seen in FIG. 3a, a spread of the radiation is refracted, which radiation spread extends in a plane orthogonal to a longitudinal direction of the semi-finished fiber ribbons (in the drawing, a spread of this type lies in the (x, y) plane which is the plane of the drawing in FIG. 3a). In contrast thereto, FIG. 3b shows that the optical component 350 does not refract a spread which extends in a plane parallel to the longitudinal direction of the semi-finished fiber ribbons, so that the radiation spreads out along the semi-finished fiber ribbons (of which only semi-finished fiber ribbon 20a can be seen in FIG. 3b due to the perspective); in this case, the mentioned plane is denoted as the (x, z) plane in the drawing of FIG. 3b.

Thus, the optical component 350 with its refraction according to FIG. 3a, 3b allows an irradiation and thus a heating of the semi-finished fiber ribbons 20a, 20b, 20c which is substantially free of overlaps (and can thereby be monitored, in particular controlled particularly effectively via the respective light-emitting diodes 310a, 310b, 310c) and which nevertheless advantageously reaches a greater portion of the semi-finished fiber ribbons 20a, 20b, 20c in each case.

FIG. 4 shows an activation device 400 in use, according to a further exemplary embodiment of the present invention. Analogously to the procedure shown in FIGS. 1 and 2, the activation device 400 heats a portion of a semi-finished fiber ribbon 20 which is laid on a laying support 30 and is there pressed thereon by a compacting element 12.

The activation unit 400 comprises a light guide 470, a discharge body 480 and a plurality of light-emitting diodes 410. In the embodiment shown, the light-emitting diodes 410 are arranged such that they are spatially separated from the location to which the at least one semi-finished fiber ribbon 20 is fed on the laying support 30 (for example, the light-emitting diodes 410 can be positioned outside a forming tool in which the at least one semi-finished fiber ribbon is laid on the laying support). The radiation emitted by the light-emitting diodes 410 is fed into the light guide 470 and delivered therefrom to the discharge body 480 which, during the use shown, is arranged at least partly between the semi-finished fiber ribbon to be laid and the laying support 30. Radiation which is emitted from the light-emitting diodes 410 and is guided through the light guide 470 can issue from the discharge body 480 and, in the example shown, is projected onto a portion of the semi-finished fiber ribbon 20 to be heated and also onto a region of the laying support.

In its interior, the discharge body can comprise micro lenses which can precisely control the issue of the radiation. In particular, the discharge body can be segmented so that radiation can be directed specifically onto a portion of one (individual) or more semi-finished fiber ribbons and/or onto the laying support 30, depending on a region in which it is fed into the discharge body.

The light guide 470 preferably comprises a plurality of bundles which are respectively associated with a semi-finished fiber ribbon 20 and/or with a surface of the discharge body so that radiation which is guided through a corresponding bundle impacts on an associated semi-finished fiber ribbon 20 or passes into an associated surface of the discharge body (in order to then pass out of a further associated surface of the discharge body).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An activation device for binder activation during the production of a fiber-reinforced plastic laminate, wherein the activation device has at least one light-emitting diode for heating a portion of at least one semi-finished fiber ribbon.

2. The activation device according to claim 1, which comprises a temperature measuring device for detecting a temperature of at least one of the heated portion, the activation device, or a heated laying support.

3. The activation device according to claim 2, wherein the at least one light-emitting diode is configured to heat a plurality of semi-finished fiber ribbons, which have been laid simultaneously next to one another, in one portion, and wherein the temperature measuring device is configured to separately detect the temperature of the heated portion individually or in groups for the plurality of semi-finished fiber ribbons.

4. The activation device according to claim 1, which comprises a control unit for the light-emitting diodes.

5. The activation device according to claim 4, which has a plurality of light-emitting diodes, and wherein the control unit is configured to control at least one of the light-emitting diodes individually and the light-emitting diodes in groups.

6. The activation device according to claim 1, which comprises a light guide which is configured to transmit radiation from the at least one light-emitting diode to the portion to be heated.

7. The activation device according to claim 1, which comprises at least one optical component, which is configured to influence radiation emitted from the at least one light-emitting diode between at least one of the at least one light-emitting diode and the portion, or the at least one light-emitting diode and a laying support, radiated thereby, for the at least one semi-finished fiber ribbon.

8. The activation device according to claim 1, which is configured to be integrated into a laying head, which can move relative to a laying support, of a device for producing a fiber-reinforced plastic laminate.

9. A device for producing a fiber-reinforced plastic laminate comprising:
a feed means for feeding at least one semi-finished fiber ribbon onto a laying support,
an activation device for binder activation during the production of the fiber-reinforced plastic laminate, wherein the activation device has at least one light-emitting diode for heating a portion of at least one semi-finished fiber ribbon, and
a compacting element for pressing the heated portion of the semi-finished fiber ribbon on the laying support.

10. A method for producing a fiber-reinforced plastic laminate comprises
automatically laying at least one semi-finished fiber ribbon on a laying support,
heating at least one portion of the semi-finished fiber ribbon, and
pressing the heated portion of the semi-finished fiber ribbon on the laying support,
wherein the portion is heated by means of one or more light-emitting diode(s) of an activation device.

11. The method according to claim 10, further comprising detecting a temperature of at least one of the heated portion, the laying support, or the activation device, of the at least one light-emitting diode.

12. The method according to claim 10, wherein two or more semi-finished fiber ribbons are simultaneously laid substantially parallel on the laying support and wherein the temperature of the heated portion is detected separately for each semi-finished fiber ribbon.

13. The method according to claim 10, which comprises at least one of controlling the light-emitting diodes individually and controlling the light-emitting diodes in groups.

14. The method according to claim 10, wherein the heating procedure comprises feeding radiation from the at least one light-emitting diode into a light guide and supplying the radiant energy through the light guide to the portion of the semi-finished fiber ribbon.

15. The method according to claim 10, wherein the heating procedure comprises passing radiation through at least one optical component between at least one of the activation device and the portion and the at least one light-emitting diode and a laying support, irradiated thereby, for the at least one semi-finished fiber ribbon.
